(19) United States
(12) Patent Application Publication
(10) Pub. No.: US 2010/0177717 A1
(43) Pub. Date: Jul. 15, 2010

(54) GROUPING BASED RESOURCE ALLOCATION METHOD, METHOD FOR TRANSMITTING SIGNAL USING THE SAME, AND GROUPING BASED RESOURCE ALLOCATION CONTROLLER

(75) Inventors: Doo Hyun Sung, Gyeonggi-do (KR); Min Seok Oh, Gyeonggi-do (KR); Jin Soo Choi, Gyeonggi-do (KR); Sung Ho Moon, Gyeonggi-do (KR); Eun Jong Lee, Gyeonggi-do (KR); Kyu Jin Park, Gyeonggi-do (KR); Jae Hoon Chung, Gyeonggi-do (KR); Hyung Ho Park, Gyeonggi-do (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 12/450,885

(22) PCT Filed: Apr. 18, 2008
(86) PCT No.: PCT/KR2008/002214

§ 371 Date: Mar. 22, 2010

Related U.S. Application Data
(60) Provisional application No. 60/944,525, filed on Jun. 17, 2007.

(30) Foreign Application Priority Data
Apr. 19, 2007 (KR) 10-2007-0038284
Sep. 4, 2007 (KR) 10-2007-0089450

(51) Int. Cl. H04W 72/12

(52) U.S. Cl. 370/329

(57) ABSTRACT

A grouping based resource allocation method, a method for transmitting a signal using the same, and a grouping based resource allocation controller are disclosed. That is, the method including grouping a plurality of user equipments (UEs) to a predetermined number of groups using feedback information received from the plurality of UEs and dynamically allocating communication resources to the UEs included in the groups according to the group based feedback information and the method for transmitting the signal using the same are disclosed. In addition, a grouping based resource allocation controller including a grouping module and control module for performing the above-described method in a base station is disclosed.

### TECHNICAL FIELD

The present invention relates to a resource allocation and scheduling method in a mobile communication system and, and more particularly to a grouping based resource allocation method for improving system capability, a method for transmitting a signal using the same, and a grouping based resource allocation controller.

### BACKGROUND ART

In particular, the following explanation provides a scheduling method suitable for scheduling of real-time small-sized packets such as VoIP packets. In real-time small-sized packet communication, a general scheduling method is as follows.

FIG. 1 is a view showing the configuration of a general transmitter including a scheduler.

The configuration of the transmitter shown in FIG. 1 will be described, concentrating on the operation of the scheduler 105.

Traffic is divided according to the types thereof and is input to the scheduler 105. As shown in FIG. 1, the scheduler 105 may include a scheduling policy module 105a, a resource assignment policy module 105b, and a frequency band allocation module 105c according to the functions thereof.

The scheduling policy module 105a selects a user equipment (hereinafter, referred to as a “UE”) according to time/frequency domains on the basis of a channel quality indicator which is fed back with respect to a normal traffic. The resource assignment policy module 105b allocates a resource to real-time small-sized traffic and manages a resource allocation period and resource allocation based on a UE and a group. The frequency band allocation module 105c allocates a frequency resource using scheduling information received from the above-described policy modules.

The scheduler 105 controls the operations of a HARQ module 106, a CRC attachment unit 101, a channel coding unit 102, a modulation unit 103, and a resource mapping unit 104 of the transmitter by the operations of the above-described modules.

A method for mapping a data symbol to a subcarrier of a physical channel (a plurality of subcarriers in an orthogonal frequency division multiplexing (OFDM) scheme and a single subcarrier in a single carrier-frequency division multiple access (SC-FDMA scheme)) by the resource mapping unit 104 and transmitting it under the control of the scheduler 105 includes the following method.

FIG. 2 is a view showing a resource allocation method, wherein FIG. 2(a) shows a continuous-mode transmission method and FIG. 2(b) shows a distributed mode transmission method.

That is, the continuous-mode transmission method shown in FIG. 2(a) indicates a method for allocating resources by a localized allocation scheme, allocating data of UEs to a predetermined number of adjacent subcarriers and transmitting it. This method can be used in a channel-dependent scheduling method. The distributed-mode allocation method shown in FIG. 2(b) indicates a method for allocating resources by a distributed allocation scheme, and distributing and allocating data of UEs to an entire frequency band. In this method, since the data of the UEs is widely distributed over the entire frequency band rather than over a specific frequency band, it is possible to obtain frequency diversity gain.

Hereinafter, the features of the real-time small-sized packets, such as the VoIP packets, of a plurality of UEs and a persistent scheduling method which is generally used for the transmission of the small-sized packets will be described.

As the features of the VoIP traffic, there are periodic generation of data (generation of data at an interval of 20 ms) and the packet size of 320 bits which is significantly smaller than that of other traffic (about 1/40 of an FTP traffic). Since the size of the VoIP packet is significantly smaller than that of other packet, control signaling overhead is large in a dynamic scheduling method for transmitting a physical layer control signal with respect to the transmission of the packets. Accordingly, the persistent scheduling method shown in FIG. 3 has been mainly used.

FIG. 3 is a view showing the persistent scheduling method for continuously allocating a fixed time/frequency resource to the UE in a predetermined period.

In the persistent scheduling method, an additional control signal is not sent after resource allocation is performed through initial control signaling. That is, according to a conventional persistent scheduling method, after data transmission related information such as a data transmission period, a modulation order and a channel coding rate is transmitted/received between a base station and a UE through a control signal, the UE persistently transmits/receives uplink and downlink data to/from the base station using the same time/frequency resource.

In more detail, FIG. 3 shows an example of allocating a fixed frequency band to UE1, UE2 and UE3 with a constant assignment interval according to the persistent scheduling method, for transmission of the packets.

As described above, in the persistent scheduling method, since the additional control signal is not exchanged after the initial control signal, the time/frequency resource is allocated to a UE which does not have data to be transmitted. Accordingly, an available resource is wasted and system capability may deteriorate.

If the dynamic scheduling method for transmitting the control signal whenever the packet is transmitted is used in order to reduce the waste of the available resource, the control signaling overhead is increased as described above.

### DISCLOSURE OF INVENTION

Accordingly, the present invention is directed to a grouping based resource allocation method, a method for transmitting a signal using the same, and a grouping based resource allocation controller that substantially obviate one or more problems due to limitations and disadvantages of the related art.

An object of the present invention is to solve the above problems lies on the conventional scheduling method, and is directed to a grouping based resource allocation method which is capable of reducing control signaling overhead by grouping UEs and efficiently using an available resource by dynamically allocating resources to UEs included in a group, and a method for transmitting a signal using the same.

The object of the present invention can be achieved by providing a resource allocation method including: grouping a plurality of user equipments (UEs) to a predetermined number of groups according to feedback information received from the plurality of UEs; and transmitting group based scheduling information for dynamically allocating communication resources to the UEs included in the groups according to group based feedback information, in this case, the group based feedback information is the feedback information for the plurality of UEs included in a same group.

The grouping may be performed by a message of a upper layer equal to or higher than a second layer (L2). The feedback information may include at least one of information for minimizing the amount of group based scheduling information and information for deciding a scheme for allocating the communication resources to the UEs included in the groups.

In the embodiment of the present invention, the feedback information may include modulation and coding scheme (MCS) level information, and, in this case, the grouping may include grouping the plurality of UEs according to the MCS level information. The feedback information may further include mobility information of the plurality of UEs, and, in this case, the grouping may further include grouping the plurality of UEs according to the mobility information.

In the embodiment of the present invention, the group based scheduling information may include information for allocating specific communication resource, having an effective transmission bit corresponding to each of the group based MCS level, to the UEs included in a corresponding group.

In the embodiment of the present invention, the specific communication resource having the effective transmission bit corresponding to each of the group based MCS level may be allocated to the UEs in the corresponding group in a predetermined sequence.

The resource allocation method may further include performing inter-group movement of the plurality of UEs grouped in the grouping using the feedback information received from the plurality of UEs, per a predetermined transmission unit. At this time, the length of the predetermined transmission unit of the inter-group movement may be decided using at least one of channel states and the mobility information of the UEs.

In yet another aspect of the present invention, provided herein is a signal transmission method of a user equipment, the method including: transmitting feedback information in a predetermined transmission period; receiving group based scheduling information corresponding to a group including said UE, when the group based scheduling information includes group identification information identifying the group including said UE, and dynamic communication resource allocation information according to the group based feedback information; and transmitting the signal through a communication resource allocated according to the group based scheduling information, when the group based feedback information is the feedback information for a plurality of UEs, including said UE, included in a same group.

In yet another aspect of the present invention, provided herein is a grouping based communication resource allocation controller of a base station, the controller including: a grouping module which groups a plurality of user equipments (UEs) to a predetermined number of groups using feedback information received from the plurality of UEs; and a control module which dynamically allocates communication resources to the UEs included in the groups according to the group based feedback information, in this case, the group based feedback information is the feedback information for the UEs included in a same group.

At this time, the control module may control at least one of a channel coding unit, a data modulation unit and a resource mapping unit of the base station.

In another embodiment of this invention, a method for transmitting downlink or uplink scheduling information is provided. In this method, the BS performs grouping plurality of user equipments (UEs) to a UE group, and performing scheduling radio resources to be allocated to each of the plurality of UEs; and transmitting a group scheduling information to the UE group through MAP message, when the group scheduling information comprises group ID, and information about the radio resources allocated to each of the plurality of UEs.

Preferably, this method further comprises receiving ACK/NACK message from the UE group.

And, said transmitting group scheduling information may be performed only when the information contained in the group scheduling information is changed, and the UEs in the UE group may use previously allocated radio resource when the group scheduling information is not received.

### BRIEF DESCRIPTION OF DRAWINGS

The accompanying drawings, which are included to provide a further understanding of the invention, illustrate embodiments of the invention and together with the description serve to explain the principle of the invention.

In the drawings:

FIG. 1 is a view showing the configuration of a general transmitter including a scheduler;

FIG. 2 is a view showing a resource allocation method, wherein FIG. 2A shows a continuous-mode transmission method and FIG. 2B shows a distributed mode transmission method;

FIG. 3 is a view showing the persistent scheduling method for continuously allocating a fixed time/frequency resource to an UE in a predetermined period;

FIG. 4 is a view showing an example of scheduling according to a grouping based resource allocation method;

FIG. 5 is a flowchart illustrating a grouping based dynamic resource allocation method according to an embodiment of the present invention;

FIG. 6 is a view showing an example of scheduling in the grouping based resource allocation method according to an embodiment of the present invention;

FIG. 7 is a view showing a collision phenomenon which occurs between a persistent scheduling packet and a HARQ retransmission packet;

FIG. 8 is a view showing a group structure in order to describe a grouping method according to an embodiment of the present invention;

FIG. 9 is a view showing a case where a bitmap is used as an example of a method of reporting a UE, to which a resource will be allocated, in a group, according to an embodiment of the present invention;

FIGS. 10 and 11 are views showing a method for allocating a frequency band which will be used by the UEs to which the resources will be allocated, according to an embodiment of the present invention;

FIG. 12 is a view showing the configuration and the operation of a transmitter according to an embodiment of the present invention; and

FIG. 13 is a view showing the structure when the transmitter according to the embodiment of the present invention is applied to a multi-antenna system.

FIG. 14 shows a frame structure based on OFDMA frame.

FIG. 15 shows a method for grouping UEs according to one embodiment of this invention.

FIG. 16 shows a method for transmitting group based scheduling information according to one embodiment of this invention.

FIG. 17 shows a flowchart for grouping UEs in the system providing VoIP service according to one embodiment of this invention.

FIG. 18 shows an exemplary method for changing UE group according to the change of channel condition of the UE.

FIG. 19 shows another example of grouping UE in VoIP service.

FIG. 20 shows a method for the UE group to transmit uplink data based on scheduling information for the UE group in VoIP service according to one embodiment of this invention.

FIG. 21 shows a method for the BS to transmit downlink data based on scheduling information for the UE group in VoIP service according to one embodiment of this invention.

### BEST MODE FOR CARRYING OUT THE INVENTION

Hereinafter, the preferred embodiments of the present invention will be described with reference to the accompanying drawings. It is to be understood that the detailed description which will be disclosed along with the accompanying drawings is intended to describe the exemplary embodiments of the present invention, and is not intended to describe a unique embodiment with which the present invention can be carried out. Hereinafter, the detailed description includes detailed matters to provide full understanding of the present invention. However, it will be apparent to those skilled in the art that the present invention can be carried out without the detailed matters.

To prevent the concept of the present invention from being ambiguous, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

The present invention provides a resource allocation method which is capable of efficiently using an available resource of a system while reducing control signaling overhead. Accordingly, first, a resource allocation scheduling method through grouping will be described as a method for reducing control signaling overhead.

FIG. 4 is a view showing an example of scheduling according to a grouping based resource allocation method.

In the grouping based scheduling method, UEs are grouped into a predetermined number of groups and time/frequency resources are allocated to the respective groups. In more detail, in FIG. 4, as an example of the grouping based scheduling method, UE0 to UE3 are grouped to a group A, UE4, UE5 and UE7 are grouped to a group B, UE6 and UE8 to UE13 are grouped to a group C, and the time/frequency resources are allocated to each of the groups.

According to the above-described method, the frequency resources are continuously allocated to the UEs having data to be transmitted, according to the groups A, B and C. Similar to the persistent scheduling method, the resources are periodically allocated to the groups. However, the grouping based scheduling method is different from the persistent scheduling method in that the resources are allocated to only the UEs having data to be transmitted according to the groups as shown in FIG. 4. Since control signals are combined and are transmitted to each group, it is possible to reduce control signaling overhead compared with the general dynamic scheduling.

As shown in FIG. 4, in the case where the frequency bands allocated to the UEs of the groups according to the groups are continuously allocated (for example, in the case where 10 bands 1 to 10 are allocated to a specific group), the allocation of the frequency resources to the UEs of the group is not dynamic. Accordingly, frequency selective scheduling effect for selecting a UE having a best channel state and allocating the resources according to the frequency bands may be reduced. Thus, multi-user diversity gain effect using the frequency selective scheduling may be reduced.

In a case where the viewpoint of reducing the amount of control signaling which are combined according to the groups when the UEs are grouped is not considered, since the group based control signaling should clarify the control information for the transmission of the packets of the UEs in the group, such as a modulation order and a channel coding rate which should be used for data modulation, the reduction of the control signal overhead may not be efficient.

Accordingly, in the embodiment of the present invention, a method for allocating dynamic resources in consideration of group based feedback information is used instead of a method for allocating fixed resources to the UEs in the group. In a preferred embodiment of the present invention, when the UEs are grouped, the UEs having the common control signaling for transmission of the packets of the UEs in the group, that is, a common modulation and coding scheme (MCS) level, may be grouped in order to minimize the amount of the group based control signaling and the group may be set in consideration of the methods for allocating the resources to the groups.

FIG. 5 is a flowchart illustrating a grouping based dynamic resource allocation method according to an embodiment of the present invention.

In more detail, in a step S601, a base station groups the UEs to a predetermined number of groups using feedback information received from the plurality of UEs. The feedback information used for grouping preferably includes at least one of information for minimizing the amount of group based scheduling information, which will be described later, and information for deciding the resource allocation method such as a distributed resource allocation scheme or a localized allocation scheme to the UEs included in the group. FIG. 5 shows mobility information of the UEs and the MCS level information as an example of the feedback information.

The grouping result are preferably transmitted to the UEs through a signal (for example, RRC signaling) of a layer L2 or a upper layer thereof. By transmitting the grouping information of the UEs through a upper layer, it is possible to reduce signaling overhead in a physical layer. The grouping does not need to be performed whenever the packet is transmitted and may be performed in a predetermined period in consideration of a channel state. The setting of the grouping period according to the channel state of the UE will now be described in detail.

Next, in a step S602, the base station transmits scheduling information to the groups divided in the step S601. As described above, the UEs are grouped using the feedback information, such as MCS level, in the step S601, thus the feedback information of the UEs in each group is common. The base station transmits only one piece of scheduling information to each group so as to reduce the control signaling overhead.

The group based scheduling information transmitted in the step S602 includes information for dynamically allocating the resources to the UEs included in the groups. In more detail, if the group based feedback information received in the step S601 includes the MCS level information, the group based scheduling information transmitted in the step S602 may include information for allocating communication resources satisfying an effective transmission bit corresponding to the group based MCS level to the UEs included in the group on the basis of the received group based feedback information among all the communication resources. Here, the effective transmission bit indicates the amount of data which can be sent through one subcarrier, in consideration of the modulation order and the channel coding rate. For example, in a QPSK 1/2 coding rate, since two bits are transmitted through one symbol and are transmitted at a 1/2 channel coding rate, an actual effective transmission bit becomes one bit. The QPSK 1/2 coding rate and a 16QAM 1/4 coding rate have the same effective transmission bit number.

Now, this will be described in detail.

Real-time small-sized traffic is characterized in that a fixed small-sized packet is transmitted in a predetermined period. A representative example of such a real-time small-sized traffic is VoIP traffic. For example, in an AMR 12.2-kbps codec mode, one VoIP packet is generated at an interval of 20 ms and the size thereof is about 340 bits, which is significantly smaller than 1500 byte of an FTP packet. Since the real-time traffic is sensitive to transmission delay, in the real-time small-sized traffic, one data packet is basically transmitted during a basic transmission time (that is, during one unit time slot).

Meanwhile, in an orthogonal frequency-division multiplexing system, since the amount of data which can be transmitted through a basic resource unit (RU) can be estimated by the modulation order and the channel coding rate, a minimum MCS value which is required according to the number of resource bands (RBs) (RB may be equal to the RU) necessary for transmitting one VoIP packet may be inversely estimated. In other words, the minimum MCS value required for the number (for example, ¼, ⅓, ½, 1, 2, 3, 4, . . . ) of RBs necessary for transmission of one VoIP packet is decided. Here, since several MCS levels may be selected according to the number of necessary RUs, a lowest value is selected.

Accordingly, in the method according to the embodiment of the present invention if the base station transmits the group based MCS level in the step S602, a method of selecting a communication resource which satisfies an effective transmission bit corresponding to the group based MCS level received in the step S601 from all communication resources and allocating the communication resource to the UEs of a corresponding group may be used. That is, in the allocation of the frequency band to the UEs of the group according to the present embodiment, the MCS value based on the frequency band is searched for using channel information fed back from the grouped UEs and the UEs of the group are scheduled to the frequency band which satisfies the effective transmission bit. If there is no frequency band having the same effective transmission bit as the effective transmission bit corresponding to the group based MCS level, a frequency band having a smallest difference between the two values may be allocated.

In a RU-based distributed transmission group, it is possible to select a RU for distributed transmission so as to obtain largest frequency diversity while satisfying the effective transmission bit condition.

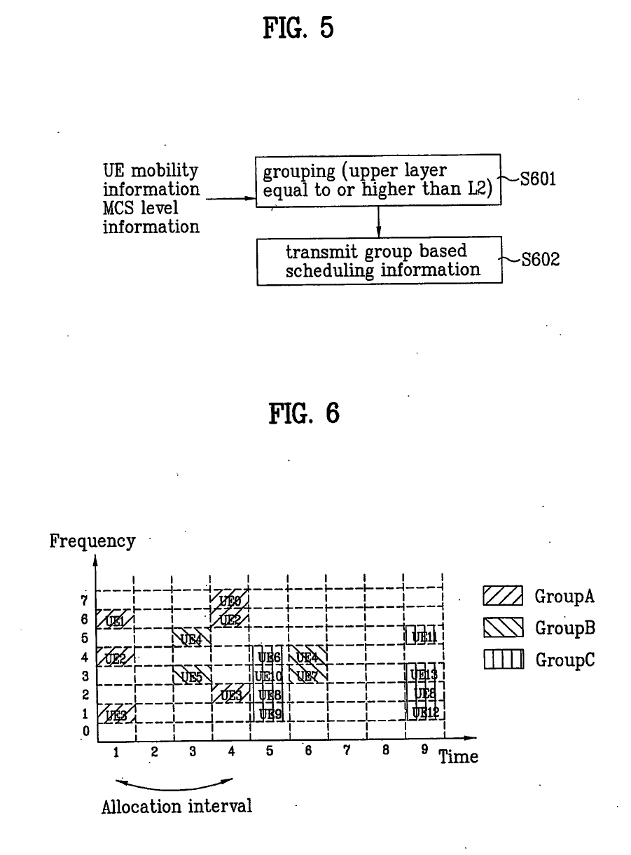

FIG. 6 is a view showing an example of scheduling in the grouping based resource allocation method according to an embodiment of the present invention.

According to the embodiment of the present invention, as described above, the plurality of UEs may be grouped using the MCS level of the UEs and/or the mobility information of the UEs. In FIG. 6, it is assumed that UE0 to UE3 are grouped to the group A, UE4, UE5 and UE7 are grouped to the group B, and UE6 and UE8 to UE13 are grouped to the group C, similar to FIG. 4, for comparison with the grouping based scheduling method of FIG. 4.

As shown in FIG. 6, according to the embodiment of the present invention, a frequency band per group is not a fixed one as described in FIG. 4 and the frequency band is dynamically allocated according to the group based feedback information. For example, if the MCS level information of the group A is fed back, the bands 1, 4 and 6 may be selected as the frequency band having the effective transmission bit corresponding to the MCS level at a time block 0 and thus the frequency band may be allocated to the UEs (for example, UE1, UE2 and UE3) for transmitting the data in the group A through the scheduling information of the group A. In addition, after a predetermined allocation interval (for example, at a time block 4), the bands 2, 6 and 7 may be selected as the frequency band having the effective transmission bit corresponding to the MCS level which is fed back from the group A and thus the frequency band may be allocated to the UEs (UE0, UE2 and UE3) for transmitting the data in the group A through the scheduling information of the group A.

Although the resource allocated to the UEs in the group is changed according to a resource allocation time point in FIG. 6, the dynamic resource allocation may vary according to the channel states of the UEs as described above.

In more detail, in the UE having low mobility or without mobility, the channel state of the frequency resource allocated at a specific time is hardly changed with time. In this case, even when the frequency band which is previously allocated is continuously used without reallocation of the frequency resource through new control signaling, it is possible to satisfy a frame error rate.

Accordingly, in the preferred embodiment of the present invention, the base station may estimate a variation in channel state with time through channel feedback information of the UE and may continuously maintain the frequency allocation resource of the UE having a small variation. In order to report the maintenance of the frequency resource, the base station may explicitly report a valid time and may insert a bit indicating the maintenance into a field for reporting the frequency band. The base station may adaptively set an effective period to the channel state of the UE.

In the embodiment of the present invention, the resource is dynamically allocated to the UEs of each group on the basis of the grouping and a period for changing the resource allocated to the UEs may vary according to the channel states of the UEs. Accordingly, an available resource can be more efficiently used and a frequency diversity gain of the UE can be obtained.

In addition, according to the embodiment of the present invention, as described above, if the resource is dynamically allocated to the UEs of the group, it is possible to prevent the collision phenomenon which may occur when the HARQ scheme is used in the conventional persistent resource allocation method. Now, the collision phenomenon will be described in detail.

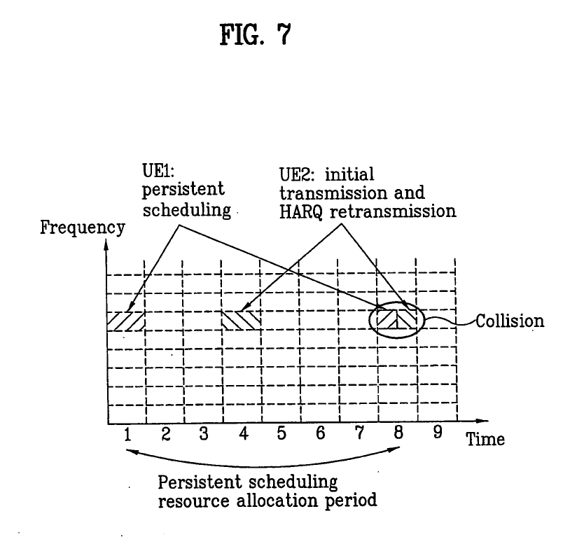

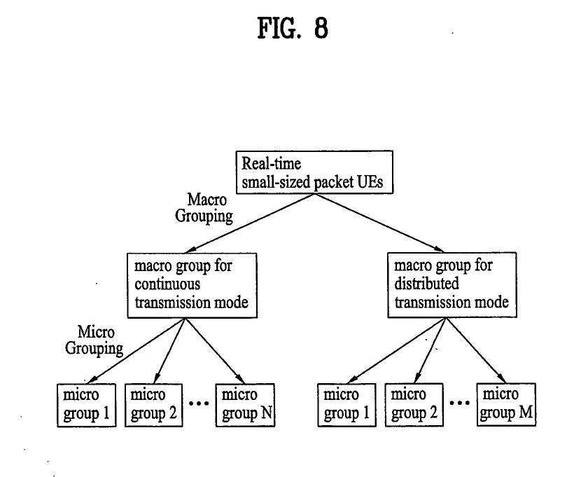

FIG. 7 is a view showing the collision phenomenon which occurs between a persistent scheduling packet and a HARQ retransmission packet.

In FIG. 7, it is assumed that the UE1 transmits a packet at time slots 1 and 8 by the conventional persistent scheduling method. In addition, it is assumed that the UE2 transmits a packet at a time slot 4, receives a NACK from a receiver, and retransmits the packet.

If the number of time slot for HARQ retransmission is 4 (that is, if a 4-channel stop-and-wait HARQ scheme is used) and the same frequency resource, modulation order and channel coding rate as the initial transmission are used according to the persistent scheduling method at the time of the retransmission as the synchronized HARQ process, the collision phenomenon that the UE1 and the UE2 use the same resource as shown in FIG. 7 occurs. That is, the conventional persistent scheduling method cannot avoid such collision.

However, in the grouping based resource allocation method according to the embodiment of the present invention, the frequency band is not allocated to the UEs of each group as a fixed one and the frequency band is dynamically allocated to the UEs of each group at a transmission time point in consideration of the received group based feedback information such that a probability that the collision with the HARQ retransmission packet described with reference to FIG. 7 occurs can be reduced.

Hereinafter, a method for grouping the plurality of UEs according to the embodiment of the present invention will be described in detail.

The grouping method according to the embodiment of the present invention may be performed by any entity for managing the plurality of UEs as well as the base station. However, the role of grouping and managing the UEs is generally performed by the base station. So, in the following description, it is assumed that the grouping is performed by the base station.

In the preferred embodiment of the present invention, the channel quality information such as the MCS level and/or the mobility information of the UE are used as criteria for performing the grouping as shown in FIG. 5.

In more detail, the UEs measure the channel states with the base station using data or a pilot signal which is received from the base station, and feeds back the channel information to the base station. According to the present embodiment, the channel quality information used for the grouping may be the MCS level, quantized signal to interference plus noise ratio (SINR) or a signal to interference ratio (SIR). In the mobility information of the UE, the UE may measure its mobility and feed back the value. The measurement of the mobility of the UE may be performed by using global positioning system (GPS) information or analyzing a variation in channel quality in a time domain. If the measurement of the mobility of the UE is impossible, the mobility of the UE may be measured using the channel quality information fed back from the base station.

FIG. 8 is a view showing a group structure in order to describe a grouping method according to an embodiment of the present invention.

According to the embodiment of the present invention, the base station groups real-time small-sized traffic UEs on the basis of the channel information fed back from the UEs. In the example of FIG. 8, the UEs may be divided into two macro groups, that is, a macro group for transmitting data in a continuous transmission mode (that is, a localized allocation scheme) and a macro group for transmitting data in a distributed transmission mode (that is, a distributed allocation scheme). In the example of FIG. 8, in each of the macro groups, the UEs are divided into micro groups. After this, the micro groups included in each of the macro group become substantial criteria for grouping the UEs in transmission of data.

Hereinafter, the grouping steps in the example of FIG. 8 will be described in detail.

First, as described above, the criterion for dividing the UEs into the macro groups as shown in FIG. 8 is the mobility of the UE. If the mobility of the UE is high, since the channel information fed back from the UE varies with time, the accuracy of the fed back channel quality information may deteriorate. In this case, since it is difficult to obtain the scheduling gain in the continuous transmission mode, it is advantageous that the data is transmitted through the distributed transmission mode.

Accordingly, in the embodiment of the present invention, if the mobility of the UE is low, a multi-user diversity gain using frequency selectivity of the channel is obtained using the continuous transmission mode and, if the mobility of the UE is high, a frequency diversity gain is obtained using the distributed transmission mode. In the UE which operates in the distributed transmission mode, it is preferable that the scheduler does not decide the frequency band according to the channel state and transmits data by a frequency band which is previously decided for distributed transmission.

Next, the case where the MCS level based on the channel quality information fed back from the UE is used as a criterion for grouping the UEs into the micro groups in each macro group in the example of FIG. 8 will be described.

As described above, the minimum MCS value may be decided according to the number of RBs necessary for transmitting one VoIP packet. If the channel state is good, one VoIP packet can be transmitted using a small number of RBs, but, if the channel state is bad, one VoIP packet can be transmitted using several RBs. Accordingly, in the present example, in the macro group using the continuous transmission mode, the UEs are grouped to the micro groups according to the effective transmission bit in consideration of the channel states on the basis of the MCS values based on the frequency band fed back from the UEs. In contrast, in the macro group using the distributed transmission mode, since the packets of the UEs are distributed in the entire frequency band and are transmitted, the UEs may be grouped to the micro groups by deciding the effective transmission bit by an average value of the channel information of the entire fed back band.

As described above, a variety of information such as the MCS level or the channel quality indicator (CQI) such as the SINR may be used as the channel quality feedback information which is the criteria for grouping the UEs into the micro groups. Accordingly, in another example of the present embodiment, as described above, the MCS level for transmitting one VoIP packet may be inversely obtained using the fed back information such as the SINR and thus the frequency resource may be allocated. If the present embodiment is applied to a TDD system, since homogeneity between a downlink channel and an uplink channel is satisfied, uplink data of the UEs may be applied to the MCS level for the transmission of the downlink data and the inter-group movement of the UE using this information is possible.

In another example of the present embodiment, as the criterion for grouping the UEs into the micro groups shown in FIG. 8 or the criterion for performing additional grouping on the basis of the micro groups divided by the MCS level, the channel state may be used according to information such as the frequency selectivity of each UE. That is, as described above, if the UEs are grouped to the micro groups according to the MCS levels of the UEs, a set of MCS levels having the same frequency spectral efficiency is additionally or separately generated and the UEs are grouped to the micro groups so as to use different MCS levels according to the channel state such as the frequency selectivity of the channel of each UE.

For example, a QPSK, a 2/3 coding rate and 16 QAM 1/3 coding rate have the same frequency spectral efficiency, but the UEs may be grouped to different micro groups according to the channel state (for example, according to whether flat fading is experienced or frequency selective fading is experienced) through different modulation orders and channel coding rates. In other words, even in the UEs using the same RU, the UEs, of which the channel rapidly varies, may be included in the group to which the MCS having a small channel coding rate (the 16 QAM or the 1/3 coding rate, in the above-described example) is applied. And the UEs, of which the channel hardly varies, may be included in the group to which the MCS having a high channel coding rate (the QPSK or the 2/3 coding rate in the above-described example) is applied.

According to the embodiment of the present invention, the base station may inform the UEs in the group of non-variable information of the group such as the group ID and the MCS level to be used through a upper layer message such as a RRC message before the data is transmitted to the groups after the UEs are grouped to the macro/micro groups. After the grouping information is transmitted, the base station may inform the UEs of the group of scheduling information relating to the resource allocation at the time of transmitting the data of the UEs through L1/L2 control signaling. Such a control signal may be transmitted through a broadcasting channel (BCH) or a shared control channel.

In a preferred embodiment of the present invention, the UEs may be periodically moved between the groups according to the states of the UEs after initial grouping of UEs. The inter-group movement of the UEs may be made in at least a transmission period. In other words, the group of the UEs may be changed when next transmission is performed after one transmission. However, this case corresponds to the case that the channel state or the mobility of the UE rapidly varies. Generally, it is preferable that the UEs are set to be moved between the groups after the transmission is performed through the group, which is previously decided, during several seconds.

The inter-group movement of the UEs may be performed between the macro group for the continuous transmission and the macro group for the distributed transmission according to the variation in mobility of the UE. If the channel state is changed in a range in which the mobility is not significantly changed, the movement of the UEs between the micro groups in the macro group may be made. Even when both the mobility and the channel state are changed, the movement of the UEs between the macro groups and/or the micro groups is possible.

In a preferred embodiment of the present invention, the scheduling of real-time small-sized packet traffic such as the VoIP is performed, the modulation orders and the channel coding rates are unified according to the groups and the scheduler may be allowed to dynamically allocate the frequency band suitable for the MCS level decided according to the UEs in the group. Since the frequency band is dynamically allocated, the band having the good channel state may be allocated to the UEs having traffic other than the real-time small-sized packet so as to transmit the data. Thus, it is possible to increase the multi-user diversity gain effect. In order to improve the system capability, the UEs may transmit data while being moved between the groups, according to the channel states or the mobility.

When the plurality of UEs are grouped to one group, the generation period of the uplink/downlink data of the UEs may be different from each other. Accordingly, in order to implement the embodiment of the present invention, it should be reported which UE in the group transmits the uplink data or receives the downlink data, and information about the communication resource allocated to the UEs should be provided. Hereinafter, a method of specifying the UE, to which the resource is allocated, among the UEs in each group and reporting the position of the resource to be used by the scheduler of the base station will be described as an example of implementing the embodiment of the present invention.

As described above, if the scheduler partially specifies some UEs as the one to which the resource is allocated among the UEs in the group, a bitmap having the number of all UEs may be made and the UEs related to the transmission may be displayed. That is, a bitmap portion corresponding to the UE participating in the data transmission in the group may be denoted by 1 and a bitmap portion corresponding to the UE which does not participate in the data transmission in the group may be denoted by 0. In contrast, a bitmap portion corresponding to the UE participating in the data transmission in the group may be denoted by 0 and a bitmap portion corresponding to the UE which does not participate in the data transmission in the group may be denoted by 1. At this time, information indicating which position of the bitmap based on the UE corresponds to which UE may be transmitted through the control signaling of a upper layer equal to or higher than a second layer (L2 layer).

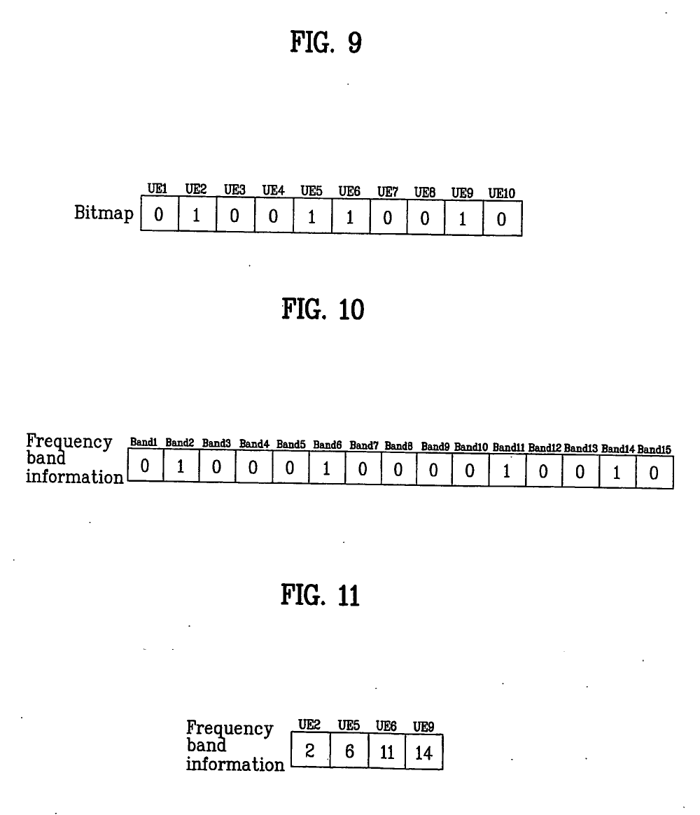

FIG. 9 is a view showing a case where a bitmap is used as an example of a method of reporting a UE, to which a resource will be allocated, in a group, according to an embodiment of the present invention.

All the UEs in the group shown in FIG. 9 are ten UEs, that is, UE1 to UE10. As shown in FIG. 9, the data transmitting UE may be denoted by 0 or 1 in the bitmap of the UEs. If it is assumed that the data transmission UE is denoted by 1, the UE2, UE5, UE6 and UE9 are the UEs participating in the transmission at this time slot in the bitmap shown in FIG. 9. In contrast, if the data transmitting UE is denoted by 0, the UE1, UE3, UE4, UE7, UE8 and UE10 are the UEs participating in the transmission in the bitmap shown in FIG. 9.

The scheduler should report the UE which will participate in the data transmission in the group at a transmission time point and provide detailed information about the resource which will be used by the UEs, such that the UE transmits the data.

In the group for the continuous transmission mode, since the number of the RUs used by the UEs is previously decided according to the groups, the data transmission UEs report the frequency band, which will be used by the UE, at a start RU point. The information about the frequency band may be reported by a method of using the bitmap or by a method of explicitly reporting the position value of the frequency band, which will be described with reference to the drawings.

FIGS. 10 and 11 are views showing a method for allocating a frequency band which will be used by the UEs to which the resources will be allocated, according to an embodiment of the present invention.

In more detail, FIG. 10 shows a method of reporting the frequency band, which will be used by the data transmission UEs, using a bitmap. FIG. 11 shows a method of explicitly reporting the position of the frequency band which will be used by the data transmission UEs.

That is, in the present example, it is assumed that the frequency band is divided into 15 subbands and each UE transmits data using one RU. In the examples, FIGS. 10 and 11 show the case where the position of the band to be used is reported to the data transmission UE by the bitmap of the UE of FIG. 9.

As shown in FIG. 10, in the method of using the bitmap in order to report the band to be used, the allocated frequency band is displayed in the same sequence as the bitmap of the UE shown in FIG. 9. In other words, since the data is transmitted in sequence of UE2, UE5, UE6 and UE9 in the bitmap of the UE, the bands denoted by 1 (of course, the roles of 0 and 1 are exchanged with each other like the description of the bitmap of the UE) are sequentially read from the frequency band information. The band 2 is allocated to the UE2, the band 6 is allocated to the UE5, the band 11 is allocated to the UE6, and the band 14 is allocated to the UE9.

As shown in FIG. 11, the same band allocation information may be explicitly reported to the data transmission UEs. That is, in FIG. 11, as described above, it may be explicitly reported that the bands which will be used by the UE2, the UE5, the UE6 and the UE9 are 2, 6, 11 and 14, respectively.

In addition, in the UEs included in the group using the distributed transmission mode, a method for reporting a predetermined subcarrier distribution method may be used.

If the grouping based dynamic resource allocation method according to the embodiment of the present invention is applied to a MIMO system having multiple antennas, additional merits are as follows.

For example, if at least two UEs are allocated to the same frequency band in the downlink multi-user MIMO situation, MCS information can be also shared when the UEs in one group are allocated and thus the amount of control signaling can be further reduced. Even in an uplink multi-user MIMO or virtual MIMO situation, when an uplink resource is allocated to the UEs included in one group, the control signaling overhead is reduced by the unified MCS.

Hereinafter, the configuration of the device for performing the grouping based dynamic resource allocation method according to the embodiment of the present invention will be described.

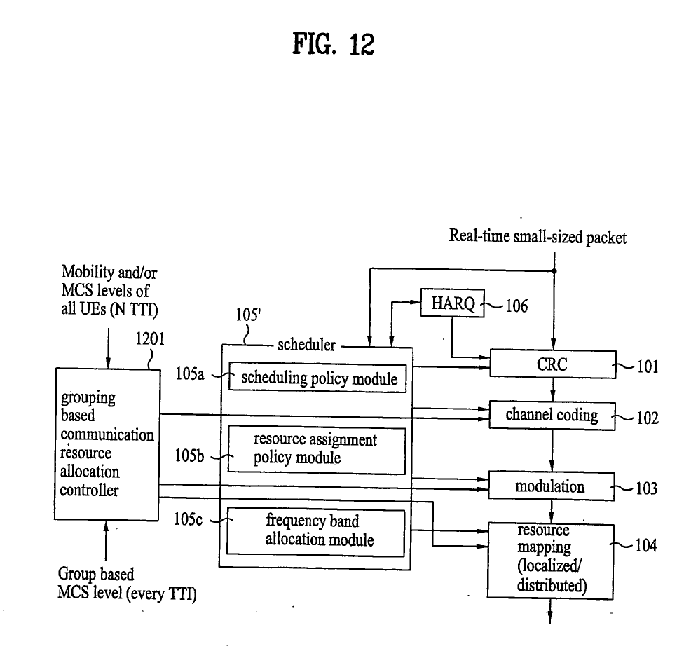

FIG. 12 is a view showing the configuration and the operation of a transmitter according to an embodiment of the present invention.

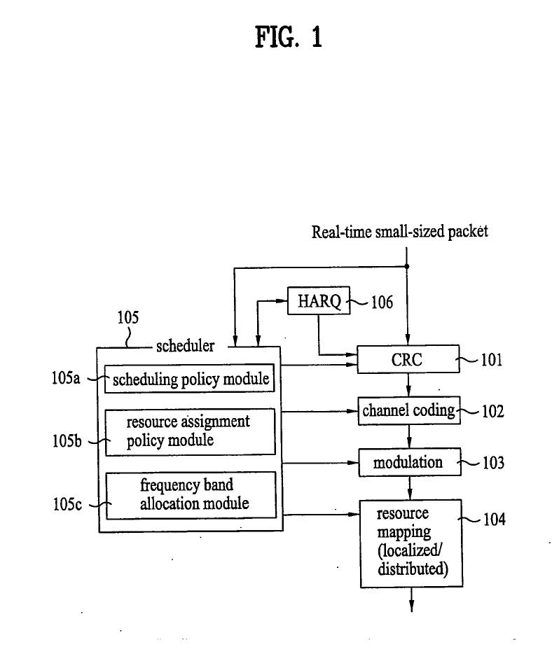

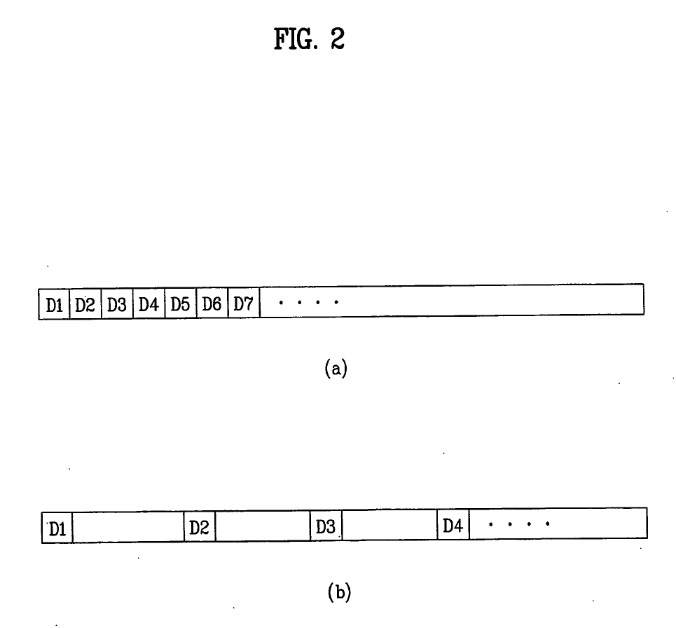

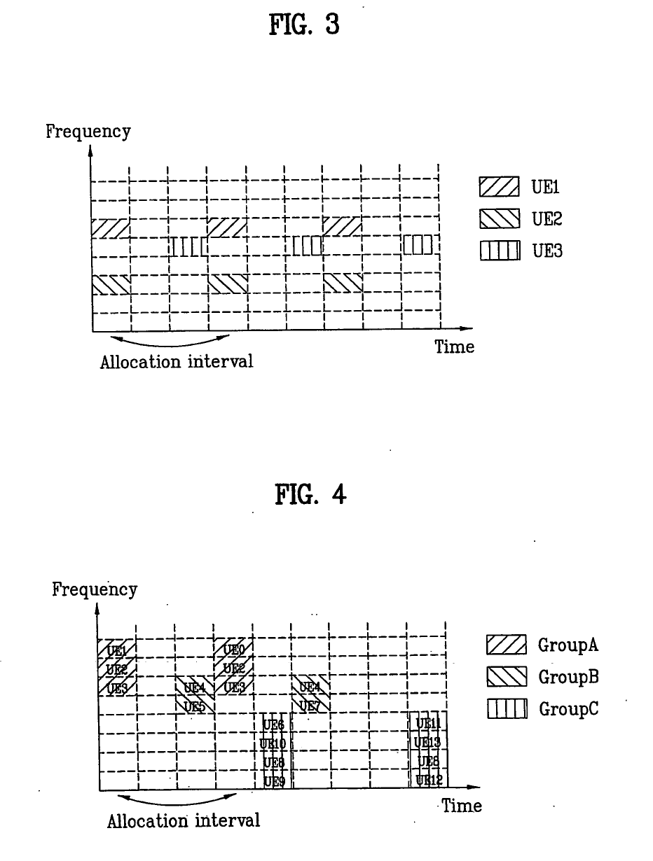

As shown in FIG. 12, a scheduler 105′ according to the embodiment of the present invention is similar to the conventional scheduler 105 shown in FIG. 1 except that a grouping based communication resource allocation controller 1201 is added. Accordingly, hereinafter, the configuration and the operation of the grouping based communication resource allocation controller 1201 in the scheduler 105′ will be described.

The grouping based communication resource allocation controller 1201 according to the embodiment of the present invention may include a grouping module (not shown) for grouping the UEs to a predetermined number of groups using the feedback information received from the plurality of UEs, and a control module (not shown) for dynamically allocating communication resources to the UEs included in the groups according to group based feedback information. In the grouping based communication resource allocation controller 1201 according to the present embodiment, the modules may be differently configured according to the functions if the grouping method using the feedback information from the UEs and the resource allocation control function according to the group based feedback information can be performed.

As shown in FIG. 12, the grouping based communication resource allocation module 1201 and more preferably the control module of the grouping based communication resource allocation module may control at least one of a channel coding unit 102, a data modulation unit 103 and a resource mapping unit 104 of the base station according to the type of the operation. For example, in the UE group to which the resource is allocated in the distributed mode using the mobility information of the UE, the grouping based communication resource allocation controller 1201 may control the mapping operation of the resource mapping unit 104 so as to allocate the resource to the group in the distributed mode. If the MCS level is received as the group based feedback information of the grouped UEs, the grouping based communication resource allocation controller 1201 controls the operations of the channel coding unit 102 and the modulation unit 103 according to the received MCS level and controls the resource mapping unit 104 to allocate the modulated data to the communication resource having the effective transmission bit corresponding to the MCS level among the communication resources.

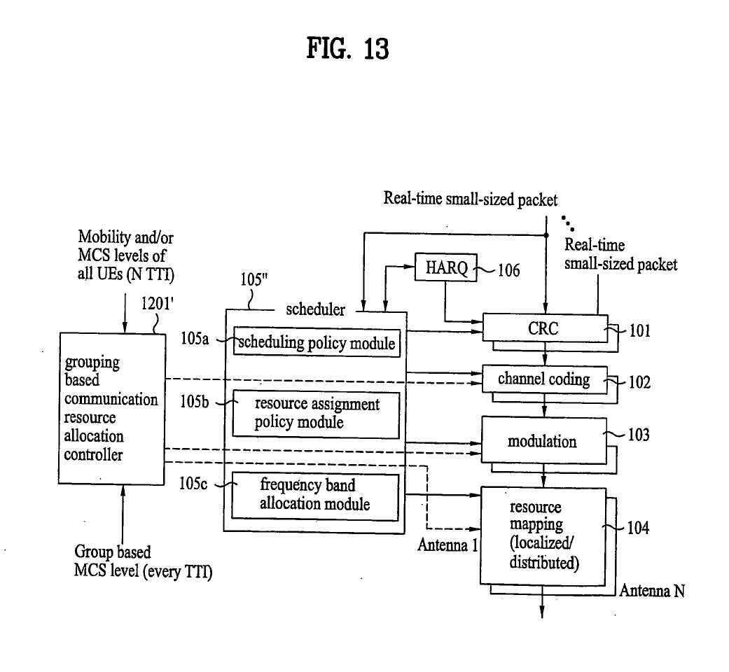

FIG. 13 is a view showing the structure when the transmitter according to the embodiment of the present invention is applied to a multi-antenna system.

As described above, the grouping based dynamic resource allocation method according to the embodiment of the present invention is applicable to the MIMO environment. In this case, if a specific frequency band is shared by the plurality of UEs, control information such as the MCS level can be shared and thus control signaling overhead can be further reduced.

The grouping based communication resource allocation controller 1201 shown in FIG. 13 is similar to the communication resource allocation controller 1201 shown in FIG. 12 except that a process of performing channel coding, modulation and resource mapping of the data transmitted through a plurality of antennas is controlled. That is, since the grouping based communication resource allocation controller 1201′ shown in FIG. 13 controls the transmission of the plurality of data transmitted through the plurality of antennas using the same feedback information, it is possible to further reduce the control signaling overhead.

Hereinafter, method for transmitting scheduling information and transmitting data will be disclosed as another aspect of this invention.

As stated, BS (base station) should transmit more control information as the number of UEs increase. Particularly, VoIP service provides service to a lot of UEs while the voice packet size is relatively small. So the overhead due to the control signal transmission in VoIP service is relatively large. For example, the number of VoIP service users per 1 MHz is 40˜50. So, if we think bandwidth of 10 MHz, BS should support 400˜500 users.

The size of voice packet generated with voice codex is approximately 260 bits, which is 1/10˜ 1/20 of the other data packet size. This small size of the voice packet and large number of user to be supported by one BS make the overhead become large. For example, if we consider voice activity factor of 40%, voice encoding period of 20 ms, frame period of 5 ms, 40˜50 active users are supported by one frame. If ROHC (Robust Header Compression) is applied, the size of the active voice packet is approximately 350 bits at active state, and 150 bits at silent state. That means the overhead due to control signaling is larger than the voice packet. So, the method for reducing control information overhead according to large number of users within limited communication resource is needed.

So, the present invention provides method for transmitting scheduling information and transmitting data based on grouping to reduce control signal overhead. For this, basic frame structure will be explained.

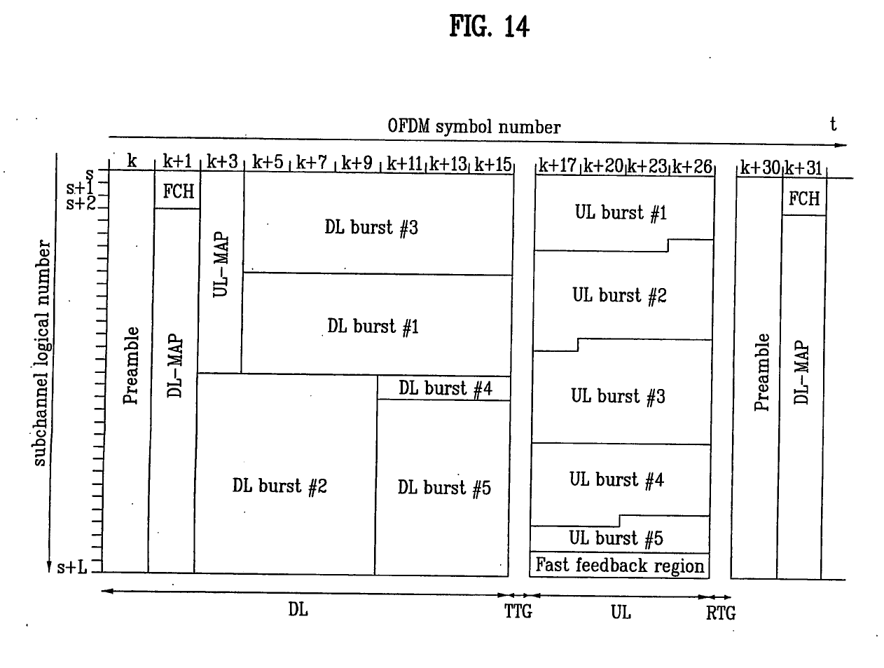

FIG. 14 shows a frame structure based on OFDMA frame.

As shown in the FIG. 14, a frame includes uplink frame portion and downlink frame portion. TDD (Time Division Duplex) is a method using the same frequency region for uplink and downlink, but using different time region for uplink and downlink. In the FIG. 14, TDD is applied and downlink region is prior to uplink region in time axis.

The downlink frame region comprises preamble, FCH (Frame Control Header), DL_MAP, UL_MAP, DL bursts. And the uplink frame region comprises UL bursts. TTG (transmit/receive time gap) is a time gap between downlink bursts and uplink bursts. And, RTG (receive/transmit time gap) is a time gap between uplink burst and downlink frame region of next frame.

The preamble is used for initial synchronization, cell search, estimation of frequency offset and channel estimation. FCH comprises information about the length of DL_MAP and coding scheme of DL_MAP. DL_MAP is a region for transmitting DL_MAP message defining downlink channel connection. DL_MAP message comprises count information for change of DCD (Downlink Channel Descriptor) and BS ID. DCD describe downlink burst profile applied to current MAP. Downlink burst profile means characteristic of downlink physical channel, and DCD is transmitted by BS periodically.

UL_MAP is a region for transmitting UL_MAP message defining uplink channel connection. UL_MAP message comprises count information for change of UCD (Uplink Channel Descriptor) and effective starting time of uplink allocation defined by UL_MAP. UCD describe uplink burst profile. The uplink burst profile means the characteristic of uplink physical channel, and UCD is transmitted by BS periodically.

If DL_MAP is 256 slots, the modulation is performed by QPSK, and 1/8 coding rate is applied, the actual amount of MAP information approximately 2960 bits. If we suppose transmitting resource allocation information using this MAP information to VoIP users, 684 bits are needed for transmitting to 40 users, 844 bits are needed for transmitting to 50 users. That is, for supporting VoIP user, ⅓ of DL_MAP is used for transmitting resource allocation information. This MAP overhead is the reason for reducing cell throughput of the BS.

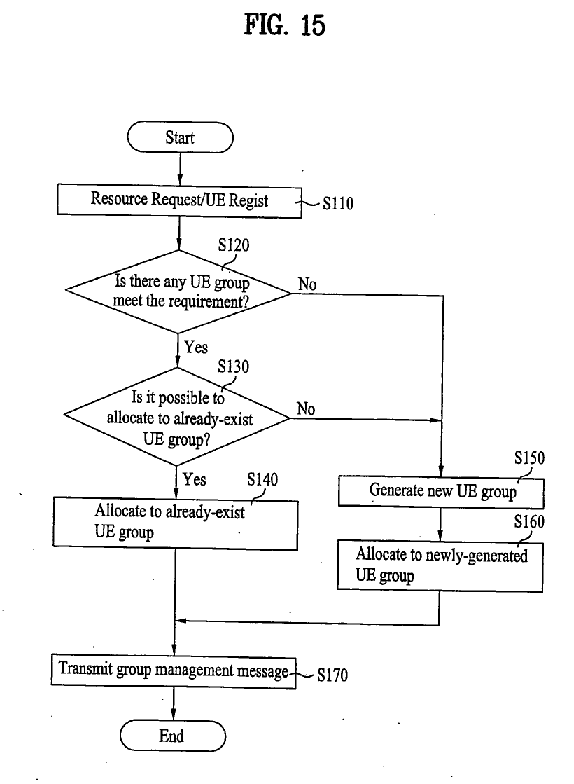

FIG. 15 shows a method for grouping UEs according to one embodiment of this invention.

As shown in FIG. 15, BS can receive uplink/downlink resource request from UEs, and/or UEs can enter the cell of the BS and registered by the BS (S110). And, BS may determine whether there is any UE group meets the predetermined requirement. In this case, the predetermined requirement may be a geometry value according to the position of the UE. And, the predetermined requirement may be a period of radio resource allocated to UE. And, the predetermined requirement may be predetermined MCS level to be applied to the UE. This predetermined requirement may be defined variously according to the system requirement. Also, BS can determine the predetermined requirement arbitrarily.

And, if there is a UE group meeting the predetermined requirement, BS may determine whether there is a room in the UE group to have extra UE (S130). If it is possible to allocate UE to already-exist UE group, the BS may allocate UE to that UE group (S140). In this example, the already-exist UE group may be the UE group comprising at least one UE meeting the predetermined requirement, or the UE group pre-generated in accordance with the predetermined requirement by the BS.

BS may generate new UE group, if there is no UE group meeting the predetermined requirement (S150). Then, the BS may allocate UE to the newly-generated UE group (S160).

Then, the BS may transmit group management message to UEs (S170). The group management message comprises information about the UEs allocated to the group. This group management message may be transmitted by unicast scheme, multicasting scheme or broadcasting scheme.

And, the group management message may comprise UE group ID, information about the UE position within the group, common information which is common to the group, etc. In this case, the UE position within the group means the order of UE to be allocated radio resource within the group. And, common information may be the predetermined requirement used for generating that group.

The group management message may be transmitted through MAC (media access control) management message. Table 1 below shows an exemplary definition of MAC management message indicating UE group management information.

TABLE 1

| Type | Message name | Message description | Connection ID |
|---|---|---|---|
| — | GRP_MGMT | VoIP group management | Basic or primary |
| | | message | management |

In the table 1, “type” is for identification of each MAC management message. “GRP_MGMT” in “Message name” field indicates this message is for group management. “Message description” field is for describing information for grouping, and here, it indicates this message is VoIP group management message. Connection ID may be basic CID (Connection identifier) or primary CID. This CID may be loaded in MAC header. Here, the basic CID is the CID given to UE during initial ranging, and the primary CID is the CID given to UE after the initial ranging. Basic CID is for the MAC management message sensitive to delay, and may be used prior to the primary CID.

Next, table 2 below shows the exemplary form of MAC management message comprising information for the UE group.

TABLE 2

| Syntax | Note |
|---|---|
| GRP_MGMT_Message_Format( ) | |
| { | |
| Management Message Type= | |
| Group ID | Allocated group ID for the |
| | UE group |
| Position | The allocation position of |
| | UEs |
| DIUC | |
| Repetition Coding factor | 0b00 - No repetition coding |
| | 0b01 - Repetition coding of |
| | 2 used |
| | 0b10 - Repetition coding of |
| | 4 used |
| | 0b11 - Repetition coding of |
| | 6 used |
| Possible resource | |
| allocation information | |
| Padding | Shall set to zero |

In the table 2, “Management message type” is an identifier for indicating this message is group management message. “Group ID” is an identifier for indicating the allocated group ID for the UE group. Generally, the group ID may be set to have 16 bits like CID. And, the “position” field indicates sequential order of the each UE to be allocated radio resource when the corresponding group allocated radio resource. This position field can be defined to have a bitmap form.

The size of the position field corresponds to the number of UEs allocated to one group. So, the size of the position field can be acquired as follows.

n=┌ log₂P┐ [Equation 1]

Here, “n” indicates the number of bits for position field, “P” is the number of UEs in the UE group, ┌*┐ is a function that make the minimum integer greater than “*”.

And, “possible resource allocation information” indicates the amount of allowable resource to be allocated to UEs.

According to one embodiment of this invention, if specific UE becomes not meeting the predetermined requirement used for the grouping because of the change of system environment due to, for example, the movement of that UE, BS may allocate this UE to other UE group. In this case, BS may transmit group management message about the new group to that UE. This group management message can be transmitted by unicast, multicast or broadcast channel.

Also, according to another embodiment of this invention, one UE can belong to multiple groups. In this case, the group management message transmitted to that UE may comprise information about the multiple groups.

BS may allocate UE to new UE group because there is no UE group meeting the predetermined requirement. And, it is possible that specific group has only one UE because other UEs in that group leaved that group. In these cases, one UE can operate link one group, and CID of the UE can be used as a group ID.

After grouping the UEs and transmitting the group management message, BS may perform scheduling based on the grouping. BS may transmit group based scheduling information to UEs. Hereinafter, method for transmitting group based scheduling information is explained.

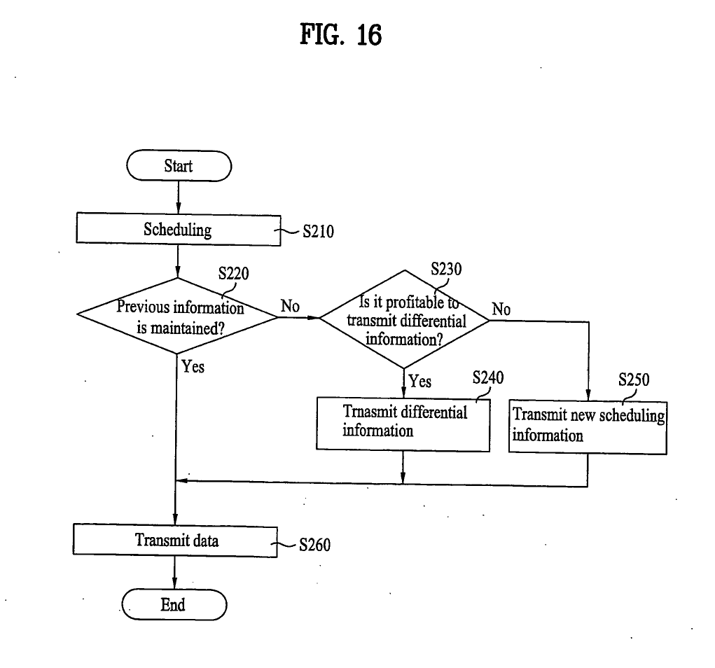

FIG. 16 shows a method for transmitting group based scheduling information according to one embodiment of this invention.

As show in the FIG. 16, BS may schedule the radio resource based on grouping (S210). BS may allocate radio resource sequentially according to the position of each UE within the group.

According to the scheduling result, BS may decide whether the previous resource allocation information is maintained (S220). That is, BS may determine whether the position of the UEs within the group is changed, whether the amount of radio resource to be allocated to each UE is changed, whether new UE is allocated to that UE group, whether UE included in the corresponding UE group leaved that group, etc. If the previous resource allocation is still valid, BS may not transmit scheduling information. UEs no receiving the scheduling information from BS may think the resource allocation is same to the previous allocation, and use the same radio resource.

If the previous resource allocation is not valid, BS may decide whether transmitting only the differential information indicating the difference between previous resource allocation and current resource allocation is beneficial (S230). This differential information may indicate the amount of changed resource allocated to each UE within the UE group. And, this differential information may indicate the amount of changed resource allocated to the corresponding group due to joining or leaving of UEs to/from the group. BS may transmit this differential information when the amount of change is not large. Using this differential information, the overhead due to the transmission of scheduling information can be reduced.

As stated above, BS may transmit differential information (S240). In this case, BS may transmit the changed amount of allocated resource, or transmit difference value between the amount of previously allocated resource and the amount of currently allocated resource.

If BS decided not to transmit scheduling information as a differential form, the BS may transmit new scheduling information as normal form (S250). This may be happened when the BS decided transmitting the scheduling information as a differential form will induce more overhead due to large difference.

According to the above stated process, BS transmits one scheduling message to each UE group. That is, the scheduling information is not generated/transmitted for the each UE, generated/transmitted based on the UE group. Then, each UE can acquire information about the radio resource allocated to itself from the scheduling information for the group.

Scheduling information may be transmitted through MAP message. MAP message is a message defining uplink resource or downlink resource. Table 3 below shows an exemplary MAP message indicating scheduling information for UE group.

TABLE 3

| Syntax | Description |
|---|---|
| New or re-transmission | Indicator for new or re- |
| | transmission |
| Group ID | Group ID |
| Number of allocated users | Number of allocated users |
| Allocated users indication | Allocated users indication |
| Time/Frequency Resource | Time/Frequency Resource |
| indication to allocated users | indication to allocated users |

In the table 3, “new or re-transmission” indicates the scheduling information is for normal transmission transmitted in the normal transmission timing or the scheduling information for HARQ retransmission. And, “group ID” is an identifier identifying UE group, and can be set by 16 bits like CID. And, “number of allocated users” indicates the number of users belong to UE group. And, “allocated user indication” is an indicator identifying specific UE among the UE group. The “number of allocated users” and the “Allocated users indication” can have a variable bit length according to the number of UEs. And, “Time/Frequency Resource indication to allocated users” indicates the time/frequency region allocated to the UE.

The scheduling information may be transmitted periodically or be transmitted at randomly chosen timing. And, the scheduling information may be transmitted in various forms according to the transmission period. For example, table 4 below can be a form of scheduling information indicating the allocated radio resource to each UE in the UE group.

TABLE 4

| | t1 | t2 | t3 |
|---|---|---|---|
| UE 1 | 10 | 10 | 10 |
| UE 2 | 20 | 20 | 20 |
| UE 3 | 10 | 10 | 20 |
| UE 4 | 0 | 0 | 0 |
| UE 5 | — | — | 20 |

In the example of the table 4, at the transmission timing of “t1”, the UE group contains 4 UEs in the group, and the radio resource is allocated to 3 UEs in the group. At the transmission timing of “t2”, the radio resource is allocated same to the timing of “t1”. At the transmission timing of “t3” the amount of radio resource allocated to UE 3 is changed from “10” to “20”. And the UE 5 is added to the group and the amount of radio resource allocated to the UE 5 is “20”.

In one embodiment of this invention, the BS may transmit scheduling information at every transmission timings of “t1”, “t2” and “t3”.

And, another embodiment of this invention, the BS may transmit scheduling information only when there is a change in the allocated resource. That is, in the above example, the BS may not transmit scheduling information at the timing of “t2”, and restart transmission at the timing of “t3”.

And, the BS may transmit only the differential information when there is a change in the allocated radio resource. That is, the BS may not transmit the scheduling information at the timing of “t2”, and transmit scheduling information indicating the changed allocation of the resource, such as ‘UE 3=20’ and ‘UE 5=20’. And, the BS may transmit the differential information only indicating the amount of change to the each of the UEs, such as ‘UE 3=10’ and ‘UE 5=20’.

The amount of allocated resource may be expressed as a combination of bits. Table 5 below shows exemplary scheduling information as a bit combination form.

TABLE 5

| The Amount of allocated resource | Bits |
|---|---|
| 0 | 0b00 |
| 10 | 0b01 |
| 20 | 0b10 |
| 30 | 0b11 |

In the table 5, the amount of the radio resource of “0” is represented by ‘0b00’, “10” is represented by ‘0b01’, “20” is represented by ‘0b10’, and “30” is represented by ‘0b11’. That is, the amount of radio resource is segmented by the predetermined value, and represented by several bit combinations. This bit combination indicating the allocated radio resource may be transmitted through group management message. The amount of the resource and the number of bits in the above explanation is only for the example.

The BS may transmit downlink data according to the scheduling result, and the UEs may transmit uplink data according to the scheduling result. The downlink data and uplink data may have group ID in the scheduling information. The BS may receive the uplink data according to the scheduling information and the UEs may receive the downlink data according to the scheduling information. The downlink data transmitted by the BS is the data transmitted to each of the UEs in the IE group, and may have different information for each UE. The uplink data transmitted by each of the UEs may be different from each other. This is different from the multicast data transmitting by the BS the same data to each of the UE group.

The above mentioned method of grouping UEs, and scheduling the radio resource per each UE group may be applied the system requiring real time service, such as, VoIP service and internet game.

Hereinafter, the method of grouping UEs and scheduling based on the grouping in the system providing VoIP service is explained. First, the UE grouping is explained.

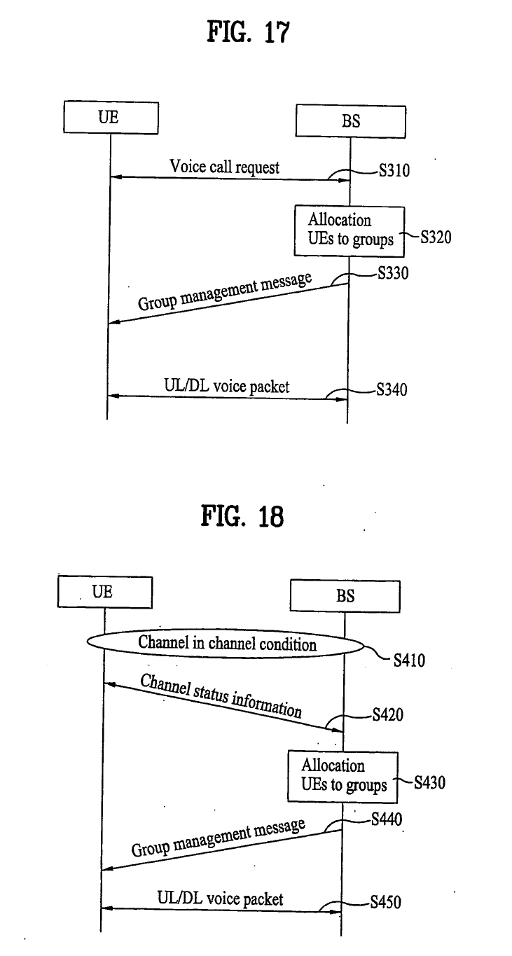

FIG. 17 shows a flowchart for grouping UEs in the system providing VoIP service according to one embodiment of this invention.

As shown in the FIG. 17, the UE and the BS transmits/receives voice call request message (S310). By this message, the UE can request new voice call to the BS and the BS can inform the UE of the call from other UE. And, the voice call request message may be occurred when the UE changed the UE group or UE performed handoff due to the movement of the UE.

Then, the BS allocates the UE to specific UE group (S320). As stated above, the position of the UE and the channel statue between the UE and the BS may be considered to decide the UE group. For example, when the UE transmit the voice packet by distributed allocation scheme for acquiring frequency diversity, the channel may be affected by the long term fading, such as, path loss, shadowing rather than by the short term fading, such as, frequency selective fading. Based on this, the BS may set the MCS level for each UE group, and select the UE group for the allocation of the specific UE meeting the above mentioned MCS requirement. If the specific UE is decided to be allocated to UE group A but the UE group A could not received additional UE, the BS may generate new UE group A′ and allocate the specific UE to the UE group A′.

Then, the BS transmits the group management message to the specific UE (S330). The group management message may have the information about the UE group containing the specific UE. Table 6 below shows exemplary information indicating the UE group information containing each UE. This group management message may be transmitted as an independent message or may be transmitted through other control message.

TABLE 6

| Syntax | Description |
|---|---|
| Group ID | Group ID of the allocated group |
| UE's position in the group | UE's position in the group |
| Modulation and coding scheme | Modulation and coding scheme |
| Number of T/F resource to be | Number of T/F resource to be |
| allocated to the UE | allocated to the UE |
| (Number of encoded packet size) | (Number of encoded packet size) |
| Amount of each T/F resource | Amount of each T/F resource |

In the table 6, “Group ID” is an indicator indicating UE group containing the specific UE. This group ID indicator may be used for identifying the group where the UE belong to, when the UE receive this message by multicast scheme or through group management message. The group ID may have the same bit length of CID or user CID of multicast scheme. “UE's position in the group” indicates the position of the specific UE in the UE group. For example, this position information may be expressed as a bitmap form. The UE needs to acquire this position information to correctly find the data directed to that UE itself.

The BS may transmit the MCS level information at initial transmission of the group management message, and may not transmit the MCS level information at later transmission of the group management message to reduce the overhead.

“Number of time/frequency resource to be allocated to the UE” indicates the amount of resource allocated to the UE in the UE group, that is, the kind of the encoded packet size. For example, voice codec generates voice data at every 20 ms, and the generation scheme and the size of the packet can be different between the voice period and the silence period. In the case of ARM codec, 350 bits of the voice data is generated at every 20 ms during the voice period. And, in the case of RoHC, 160 bits of the data is generated at every 160 ms during the silence period. In the case of G.729 codec, no data is generated during the silence period. In the case of EVRC codec, the coding rate is variable according to the activity of the voice. Such as, 4 types of data (1, ½, ¼, ⅛) may be generated.

Generally, when the BS allocates time/frequency resource to the UE, the BS may allocate N frequency resources within unit time period and M time resources within unit frequency period to the UE (M, N is an natural number). The encoded packet size is predetermined according to the type of codec in VoIP communication. Thus, the BS may inform this through the group management message, so the overhead of the control signal in allocation of radio resource can be reduced.

Each of the ‘amount of each T/F resource’ indicates encoded packet size allocated to each of the UEs within the UE group. The UE can acquire the information about the MCS applied to the UE group containing the UE itself and the encoded packet size, so the UE can acquire the amount of the resource allocated to the UE itself.

On the other hand, the group allocation may be differently determined between uplink and downlink. For example, for the FDD (frequency division duplex) system instead of TDD (time division duplex) system, the channel status of the uplink and the downlink can be different, so the information for the downlink UE group and the uplink UE group may be differently generated and transmitted to the UE.

Then, the BS may perform scheduling of the radio resource for the UE group, and communicates voice packet according to the scheduling information (S340). The BS may transmit downlink voice packet, and the UE may transmit uplink voice packet, according to the scheduling.

After the UE group message transmitted from BS to UE, the channel condition between the BS and UE can be changed due to the movement of the UE. If all the UEs in the UE group use the same MCS, the UE having deteriorated channel couldn't decode the received data, and the UE having improved channel waists the radio resource, thus make the system performance deteriorated. So, it is needed to change the UE group for the UE whose channel is changed.

Hereinafter, a method for changing UE group for the UE having changed channel condition is explained.

FIG. 18 shows an exemplary method for changing UE group according to the change of channel condition of the UE.

As show in the FIG. 18, the channel condition between BS and UE can be changed (S410). This may be happened when the UE move to the cell edge, thus the channel condition deteriorated due to path loss and/or inter cell interference. And, this may be happened when the UE move toward the BS, thus the channel condition improved.

The UE may transmit the channel status information to the BS (S420). The channel status information may be the channel quality information (CQI). The CQI may be SINR (Signal-to-Interference and Noise Ratio), MCS level, data rate indicator, received signal indicator, and so on. This channel status information may be transmitted through whole frequency band or selected subchannel.

Then, the BS may allocate UE to appropriate UE group (S430). At this time, the UE group may be decided considering the changed MCS level of the UE. In FDD system, the MCS of the uplink and downlink can be different from each other. SO, in FDD system, the UE can be allocated to different UE group between the uplink transmission and the downlink transmission. When the UE allocated to the new UE group, old UE group may delete the UE allocated to other UE group. On the other hand, the old UE group may not delete the UE allocated to other UE group, for preventing the UE changing UE group from not receiving data.

Then, the BS may transmit the group management message to the UE (S440). This group management message may comprise information about the newly allocated UE. This group management may be expressed as show in the table 6.

And then, the BS may perform scheduling the radio resource to the UE group, and the voice packets may be transmitted/received between the BS and the UE (S450).

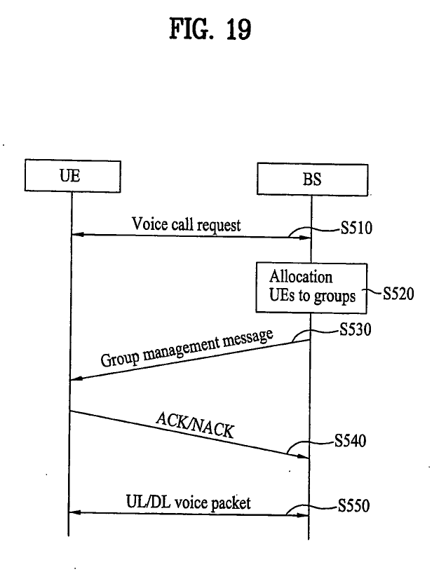

FIG. 19 shows another example of grouping UE in VoIP service.

As show in the FIG. 19, the US may transmit/receive voice call request message (S510). And, the BS may allocate the UE to appropriate UE group (S520). The, the BS may transmit group management message according to the grouping result (S530).

Then, the UE may transmit ACK/NACK signal to the BS (S540). This ACK/NACK signal is a message for confirming the reception of the group management message. The UE may transmit the ACK signal when the UE successfully decode the group management message. And the UE may transmit NACK signal when the UE can't successfully decode the group management message. This ACK/NACK message may comprise all or part of the field of the group management message. On the other hand, this ACK/NACK message may be 1 bit information.

After the BS receives the ACK signal from the UE, the BS and the UE may communicate voice packets using the group based scheduling information (S550).

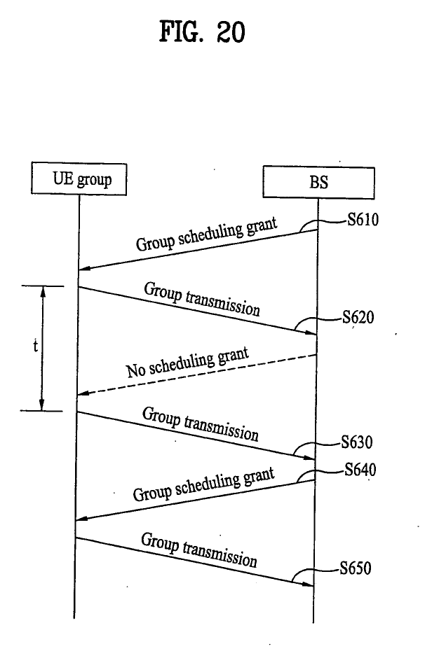

FIG. 20 shows a method for the UE group to transmit uplink data based on scheduling information for the UE group in VoIP service according to one embodiment of this invention.

First, the BS may transmit scheduling information to the UE group (S610). This scheduling information is for the whole UEs in the UE group. Each UE in the UE group receives one group scheduling information identified by group ID, not the one for each UE.

Table 7 below shows an exemplary group scheduling information. The group scheduling information may include only part of the information shown in the table 7.

TABLE 7

| Syntax | Description |
|---|---|
| New or re-transmission | Indicating whether this scheduling |
| | information is for retransmission |
| Group ID | Group ID |
| Allocated user indication | Indicate the resource is allocated |
| | to each user |
| Resource allocation indication | Resource allocation indication |
| HARQ indication | HARQ indication for each user |
| Additional indication | Additional indication |

In the table 7, “New or re-transmission” indicates whether this scheduling information is for retransmission. Indication for the retransmission may be expressed by 1 bit information. When the group scheduling information is for new transmission of the voice data, the UEs in the UE group may transmit/receive the voice packet through the same time/frequency region periodically. Because the generation period of voice packet is predetermined for each voice codec, each UE may transmit/receive voice packet according to the generation period. This resource allocation information may be changed when the new resource allocation information is received. The group scheduling information for retransmission is valid only for that retransmission.

“Group ID” indicates which UE group the group scheduling information is for. This group ID may be equal to the group ID contained in the group management message received by the UE.

“Allocated user indication” indicates whether each UE is allocated radio resource for transmitting voice packet. This field is for identifying the UE in the voice period from the UE in the silence period, because the UE in the silence period does not have voice packet to be transmitted.

“Resource allocation indication” is for the UE to transmit voice packet to identify the radio resource information. And, “HARQ indication” is for identifying the information about the channel where the error is occurred. And, “Additional indication” may comprise MIMO information commonly to be applied to the UE group or to be applied to each UE. And, the MIMO information may comprise precoding information, beamforming information, rack information, and so on.

According to the group scheduling information, the UEs in the UE group may perform group transmission (S620). That is, the UEs in the same UE group receiving the same scheduling information may generate voice packet and transmit it in the same period.

The group scheduling information may be transmitted in similar period for the voice packet. However, the voice call tend to have consecutive voice period and silence period instead of having voice period and silence period iteratively. So, the time/frequency resource once allocated may be used for some period.

So, as shown in the FIG. 20, the BS may not transmit scheduling information when the resource allocated is not changed (no scheduling grant case). So, the UE may transmit voice packet after one voice packet generation period of “t” (S630).

When the resource allocated to the UE group is changed, the BS may transmit group scheduling information (S640). That is, the BS may transmit group scheduling information when the radio resource allocated to each UE is changed and/or when new UE is allocated to the UE group.

The table 8 below shows an example of the case the resource allocation information for the UE group is changed.

TABLE 8

| | t1 | t2 | t3 |
|---|---|---|---|
| UE 1 | n | N | n |
| UE 2 | 0 | N | n |
| UE 3 | m | M | m |
| UE 4 | — | — | n |

As shown in the table 8, at the group scheduling information transmission timing of “t1”, the UE group has 3 UEs (UE 1, UE 2 and UE 3), and UE 1 is allocated “n” radio resource, UE 2 is allocated no radio resource, and UE 3 is allocated “m” radio resource.

At the group scheduling information transmission timing of “t2”, if the resource allocation to UE 2 is changed from “0” to “n”, the BS may transmit group scheduling information. In this case, the BS may transmit group scheduling information as ‘UE 2=n’, or whole scheduling information like ‘UE 1=n, UE 2=n, and UE 3==m’.

Likewise, at the group scheduling information transmission timing of “t3”, the BS may transmit group scheduling information as ‘UE 4=n’ or whole scheduling information like ‘UE 1=n, UE 2=n, UE 3=m and UE 4=n’.

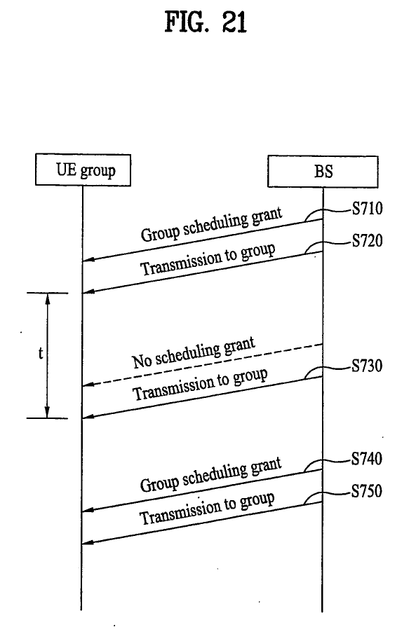

FIG. 21 shows a method for the BS to transmit downlink data based on scheduling information for the UE group in VoIP service according to one embodiment of this invention.

As shown in the FIG. 21 the BS may transmit group scheduling information the UE group (S710). This scheduling information may be identified by group ID as one group scheduling information.

And the BS may transmit downlink voice packet to the UE group (S720). That is, the BS may transmit voice data to the UEs in the UE group receiving the same group scheduling information.

As shown in the FIG. 21, if the group scheduling information is not changed, the BS may not transmit group scheduling information (no scheduling grant). So, the BS may transmit voice packet using the same resource used at previous transmission.

After one voice packet generation period of “t”, the BS may transmit next voice packet (S730). And, when the group scheduling information is changed, the BS may transmit group scheduling information (S740).

According to the method stated above, the overhead due to the scheduling information can be reduced. Particularly, in the VoIP service which needs to support many users by small packet, these methods can effectively reduce significant amount of overhead due to the scheduling information.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

### EFFECT OF THE INVENTION

According to the embodiments of the present invention, since a frequency band according to channel state information such as an MCS level is dynamically changed in a predetermined period according to the channel state of an UE or at the time of transmission, it is possible to increase a multi-user diversity gain using frequency selectivity and improve system capability.

In a specific embodiment of the present invention, since the MCS levels of the groups are unified, it is possible to reduce the amount of scheduling control signal transmitted to the UEs included in the groups and reduce signaling overhead.

In particular, the embodiments of the present invention are advantageous in transmission of the real-time small-sized packet such as the VoIP packet. That is, in the grouping based dynamic resource allocation method, if the UEs are grouped on the basis of the channel information such as the MCS levels of the UEs, since the channel information such as the MCS levels which will be used by the UEs in the group at the time of transmission is equal unlike the general packet scheduling method, it is possible to reduce the amount of control signaling by the number of bits necessary for reporting the level. For example, if the number of used MCS levels is 32, the number of bits necessary for representing the MCS levels is 5 and thus 50 bits are required in order to schedule 10 UEs. If the group scheduling is performed like the embodiments of the present invention, the MCS levels do not need to be reported as the scheduling information and thus overhead can be reduced in scheduling. The overhead amount can be reduced when the frequency resource is reallocated in every transmission period. When the frequency resource allocated to the UE of which the channel is hardly changed with time is maintained, the amount of scheduling signaling can be further reduced.

According to a specific embodiment of the present invention, since the continuous transmission mode group and the distributed transmission mode group for increasing the multi-user diversity gain are supported, the capability can be improved by the frequency diversity gain in the UEs which are hard to be subjected to link adaptation through the channel quality information feedback due to the mobility of the user.

According to a specific embodiment of the present invention, since the UEs are moved between the groups, it is possible to dynamically cope with the channel state or the mobility of the UE. Thus, the service quality of the UE does not deteriorate.

Finally, according to a specific embodiment of the present invention, since the frequency band of the UEs in the group can be dynamically changed, it is possible to prevent collision with the synchronized HARQ packet.

What is claimed is:

1. A resource allocation method comprising:
grouping a plurality of user equipments (UEs) into a predetermined number of groups according to feedback information received from the plurality of UEs; and
transmitting group based scheduling information for dynamically allocating communication resources to each of the UEs included in each of the groups according to group based feedback information,
wherein the group based feedback information is the feedback information for the UEs included in a same group.

2. The resource allocation method according to claim 1, wherein said grouping is performed by a message of a specific upper layer equal to or higher than a second layer.

3. The resource allocation method according to claim 1, wherein the feedback information includes at least one of information for minimizing an amount of the group based scheduling information and information for deciding a scheme for allocating the communication resources to the UEs included in the groups.

4. The resource allocation method according to claim 3, wherein:
the feedback information includes modulation and coding scheme (MCS) level information, and
said grouping includes grouping the plurality of UEs according to the MCS level information.

5. The resource allocation method according to claim 4, wherein:
the feedback information further includes mobility information of the plurality of UEs, and
said grouping further includes grouping the plurality of UEs according to the mobility information.

6. The resource allocation method according to claim 4, wherein the group based scheduling information includes information for allocating specific communication resource, having an effective transmission bit corresponding to each of group based MCS level, to each of the UEs included in a corresponding group.

7. The resource allocation method according to claim 6, wherein the specific communication resource having the effective transmission bit corresponding to each of the group based MCS level is allocated to the UEs in the corresponding group in a predetermined sequence.

8. The resource allocation method according to claim 1, wherein the group based scheduling information comprises first bitmap information indicating which UEs in each of the group participates in data transmission.

9. The resource allocation method according to claim 8, wherein the group based scheduling information further comprises one of second bitmap information and direct resource allocation information, indicating which communication resources is allocated to the UEs participating in data transmission.

10. The resource allocation method according to claim 1, further comprising performing inter-group movement of the plurality of UEs grouped in said grouping using the feedback information received from the plurality of UEs, per a predetermined transmission unit.

11. The resource allocation method according to claim 10, wherein a length of the predetermined transmission unit of said inter-group movement is decided using at least one of channel states and the mobility information of the UEs.

12. A signal transmission method of a user equipment (UE), the method comprising:
transmitting feedback information in a predetermined transmission period;
receiving group based scheduling information corresponding to a group including said UE, wherein the group based scheduling information includes group identification information identifying the group including said UE, and dynamic communication resource allocation information according to group based feedback information; and
transmitting the signal through a communication resource allocated according to the group based scheduling information,
wherein the group based feedback information is the feedback information for a plurality of UEs, including said UE, included in a same group.

13. A method for transmitting downlink or uplink scheduling information, the method comprising:
grouping plurality of user equipments (UEs) to a UE group, and performing scheduling radio resources to be allocated to each of the plurality of UEs; and
transmitting a group scheduling information to the UE group through MAP message,
wherein the group scheduling information comprises group ID, and information about the radio resources allocated to each of the plurality of UEs.

14. The method according to claim 13, further comprising:
receiving ACK/NACK message from the UE group.

15. The method according to claim 13, wherein said transmitting group scheduling information is performed only when the information contained in the group scheduling information is changed, and
the UEs in the UE group use previously allocated radio resource when the group scheduling information is not received.
